(19) United States
(12) Patent Application Publication
(10) Pub. No.: US 2009/0200952 A1
(43) Pub. Date: Aug. 13, 2009

(54) METHODS AND APPARATUS FOR DIMMING LIGHT SOURCES

(75) Inventor: Ray James King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PureSpectrum, Inc.

(21) Appl. No.: 12/353,551

(22) Filed: Jan. 14, 2009

Related U.S. Application Data
(63) Continuation-in-part of application No. 12/205,564, filed on Sep. 5, 2008.
(60) Provisional application No. 61/006,967, filed on Feb. 8, 2008.

(51) Int. Cl. H05B 37/02

(52) U.S. Cl. 315/206

(57) ABSTRACT

Methods and apparatus for dimming light sources are described herein. In certain embodiments, a bias circuit selectively biases a solid state switch during a portion of half-cycle of a line voltage after a settable delay. In some embodiments, the delay of the bias circuit is adjustable by a user, which varies the amount of energy provided to a light source, and the light generated there from. A charge circuit biases the switch for a period of time in the event the bias circuit experiences an operating condition (a ringing current) that may cause the switch to become open during the half-cycle of the line current. As a result of the charge circuit, the light source coupled to the line current does not experience substantial flickering and is compatible with low power compact fluorescent lights. The dimmer can be combined with other components to form a light harvesting system.

### CROSS REFERENCE TO RELATED APPLICATIONS

This application is a continuation-in-part of U.S. application Ser. No. 12/205,564 filed on Sep. 5, 2008, which in turn claims the benefit under 35 U.S.C. §119(e) to U.S. Provisional Patent Application entitled “Two-Wire Dimmer Switch for Dimmable Fluorescent Lights” filed on Feb. 8, 2008, bearing Ser. No. 61/006,967, both of which are herein incorporated by reference for all that each teaches.

### FIELD OF THE INVENTION

The present invention disclosed herein relates generally to energy saving electronic lighting devices and, more particularly, to methods and apparatus for dimming light sources in an efficient and effective manner.

### BACKGROUND OF THE INVENTION

In the field of electronic lighting ballasts, some light sources (e.g., gas discharge lamps, fluorescent lamps, etc.) generally present a negative resistance, which causes a power source to increase the amount of current provided to the light source. If not limited, the light source, or the power source, or both, would encounter a catastrophic failure. As a result, a ballast circuit is typically provided to limit the current that the power source provides to the light source.

In many applications, it is desirable to be able to dim the light source. In residential applications, dimmers are often used to create a desirable lighting atmosphere (“mood” lighting) and/or save energy. For example, in energy saving applications, dimming is involved in “daylight harvesting” to conserve energy usage. Essentially, lighting levels in a room are dimmed as daylight available from windows or skylights increases to create a constant light level. However, conventional dimmer circuits were initially designed for resistive loads, such as incandescent light bulbs. In addition, such dimmer circuits were designed to operated with loads greater than 40 watts. Using a conventional dimmer with a conventional ballast operating with a fluorescent light, can lead to problems, because fluorescent lights are not resistive loads, but reactive loads that are primarily capacitive in nature. Furthermore, many fluorescent lights, such as compact fluorescent lamps, are less than 40 watts. Thus, using a convention dimmer on a fluorescent light can lead to flicker or limited operability (dimming) of the light source. Thus, this can preclude use of a dimmer with a single conventional compact fluorescent light bulb in a lamp. As a result, conventional dimmers are typically not operated with light sources that require ballast circuits that limit the amount of current. Thus, there is a need for a two-wire dimmer that can work with fluorescent lights.

### SUMMARY OF THE INVENTION

Methods and apparatus for dimming light sources are disclosed. A dimmer circuit includes a switch to selectively couple a first node to a second node. In particular, the first node receives a line voltage from a power source which is provided to the second node when the switch is biased ON. A biasing circuit is operable to actuate the switch after a delay during each half-cycle of the line voltage. Further, the delay of the biasing circuit is typically based on a setting provided by a user. A charge circuit provides energy to the switch for a period of time to maintain the actuation of the switch for a portion of the duration of the half-cycle. In particular, the charge circuit is operable to provide energy to the switch such that the switch remains biased in the event of an operating condition that, in some instances, would cause the switch to open prematurely. This operating condition is due to a ‘ringing current’ that can cause the switch to become prematurely unlatched, causing undesirable operation. Thus, the charge circuit ensures that once the switch is biased ON, it remains ON for a portion of the duration of the half cycle, specifically during the duration that the ringing current may occur.

The charge circuit generally comprises a circuit that generates a voltage from the line voltage. The voltage generated by the charge circuit is provided in part by energy stored in a capacitor, for example. However, if the voltage generated in the charge circuit exceeds a certain threshold, a further circuit is operable to remove excess voltage from the capacitor. Further, the charge circuit comprises a second switch that is implemented by a transistor in one embodiment to provide a current to the switch in response to the switch actuating.

### BRIEF DESCRIPTION OF THE DRAWINGS

FIGS. 1a and 1b are respectively a block diagram of a prior art dimmer circuit connected to a ballast and an electrical model thereof.

FIG. 2 is a block diagram of one embodiment of a dimmable light system in accordance with aspects of the present invention.

FIG. 3 is a flow diagram of one embodiment of a process that the dimmer circuit of FIG. 2 may implement.

FIG. 4 is a schematic diagram of one embodiment of a circuit that may implement the process of FIG. 3.

FIG. 5 is another schematic diagram of another embodiment of a circuit that may implement the example process of FIG. 3.

FIGS. 6a-6d depict embodiments of the present invention for dimming a compact fluorescent bulb.

FIGS. 7a and 7b represent different amounts of energy provided to a CFL at different dimming levels.

FIG. 8 represents one embodiment of a light harvesting system.

FIG. 9 represents another embodiment of the present invention in a light-dimming system.

### DETAILED DESCRIPTION

Methods and apparatus for dimming light sources are described herein. In the described examples, a dimmer circuit allows an operator to control the intensity of the light emitted by a light source with little or no flickering of the light. In addition, the dimmer circuit can be used with ballasts for gas discharge lamps (e.g., fluorescent lamps, etc.) as well as traditional light sources (e.g., an incandescent lamp, etc.) and other types (e.g., LED, etc.). Thus, the dimming system can be used with various light sources.

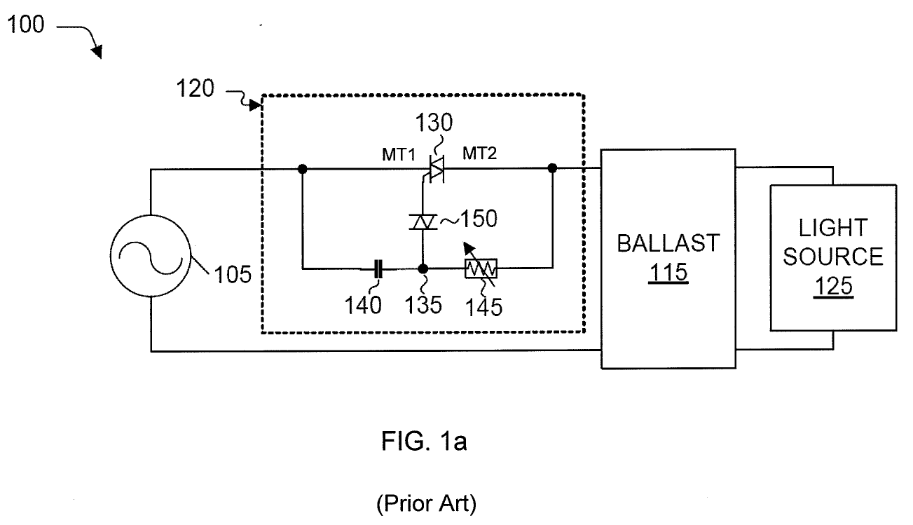

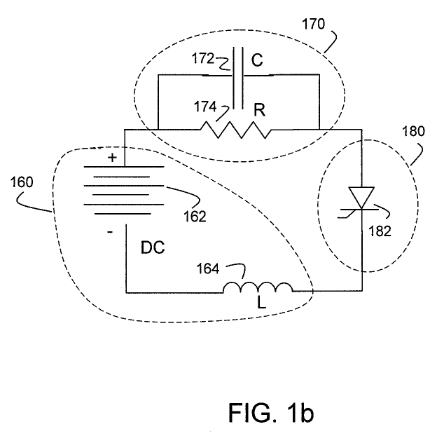

FIG. 1a illustrates a block diagram of a lighting system 100 implementing a ballast with a conventional dimmer circuit. As will be described in detail below, the conventional lighting system 100 is generally not implemented with conventional gas discharge lamps because of substantial flickering that can occur due to the interaction between a dimmer circuit 120 and a ballast 115. In FIG. 1a, a power source 105 (e.g., an alternating line voltage/current, such as a household power source, etc.), which typically has a current/voltage that alternates at a line frequency of the power source (e.g., 60 Hz in the U.S., and 50 Hz in other countries, etc.), is coupled to the ballast 115 via the dimmer circuit 120. As used herein (and excluding any material incorporated by reference), “line” in this context refers to “power line” and thus the “line frequency” is the frequency in Hertz of the current or voltage provided by the external power source. Further, generally the term “coupled” is used herein (and excluding any material incorporated by reference) in distinction from the term “connected”, whereby “coupled” means that energy (e.g., voltage or current, etc.) may be transferred from one point to another, typically via, but not necessarily, another element (resistor, diode, transistor, etc.), whereas “connected” means energy is transferred from one point to another without an intervening element, e.g., it is transferred via a wire or logical equivalent thereof. The dimmer circuit 120 limits the average voltage into ballast 115. Dimmer circuit 120 may be adjustable by an operator (the user of the dimmer) and allows the operator to limit the amount of energy provided from the dimmer circuit 120 into the ballast 115. The dimmer circuit 120 allows the operator to control the intensity of the light emitted from a light source 125 (e.g., a gas discharge lamp, an incandescent bulb, a light emitting diode (LED), etc.) coupled to ballast 115.

In FIG. 1a, dimmer circuit 120 is typically implemented by a triac 130 to control the average voltage provided from its first terminal, which is typically referred to as MT1, to its second terminal, which is typically referred to as MT2. Triac 130 generally blocks current from flowing (in either direction) until a current is applied to its gate, which causes the triac to become latched (also referred to as activated) and form a low impedance path from its first terminal to its second terminal. In particular, the triac 130 allows current to flow in both directions when a current is applied to its gate. When latched, the gate of the triac 130 cannot control its operation and a specific condition must typically occur for the triac 130 to become unlatched. This condition is generally when current flowing across its terminals, namely between MT1 and MT2 drops below a threshold, known as a holding current. In FIG. 1, the first terminal MT1 of triac 130 is coupled to a node 135 via a capacitor 140 and the second terminal MT2 of triac 130 is coupled to node 135 via an adjustable resistor 145 (e.g., a potentiometer, etc.). The operator adjusts the adjustable resistor 145 to increase or decrease the light emitted by the light source. Node 135 is coupled to the gate of triac 130 via a diac 150.

During the operation of the dimmer circuit 115, capacitor 140 and the adjustable resistor 145 form a RC network that has a time constant, which generally modifies the voltage provided from the power source presented at node 135. If the voltage at node 135 does not exceed a threshold associated with diac 150 (e.g., ±30 volts, etc.), diac 150 will not apply a current to triac 130, which allows the triac to remain OFF, thus preventing the line voltage from being presented to ballast 115. On the other hand, once the voltage at node 135 exceeds the threshold, diac 150 turns ON and applies a current to the gate of triac 130 turning it ON, thereby allowing voltage from power source 105 to be presented to the ballast 115. In this configuration, triac 130 is latched ON and does not turn OFF until a predetermined condition occurs, which is typically when the current flowing across the terminals of triac 130 drops below its holding current. Thus, the resistance value of adjustable resistor 145, in conjunction with capacitor 140, determines the time delay at which the voltage at node 135 rises to turn diac 150 ON, thereby turning the triac ON, and consequently turning light source 125 ON. This process occurs during each half-cycle of the line voltage. If the light source is turned on early in the half-cycle, more energy is provided to the light source and hence more light is typically perceived to the human eye than when the light source is turned on later in the half cycle. However, in many prior art systems, due to the design of the ballast, the energy savings when dimmed is not always corresponding to the reduction in light. In other words, it is not always the case that when the light is reduced by 25% that the energy consumed is 25% less. This provides a false impression to the user that dimming the light source saves a commensurate amount of energy. For some applications, such as daylight harvesting (where lights are automatically dimmed when the ambient sunlight increases the light in a room), the lack of corresponding energy savings negates the potential benefits of a daylight harvesting system.

In a typical commercial or residential building, many light sources are typically required. As a result, a substantial amount of in-building electrical wire is required to electrically couple the light sources to their respective power source. Generally, the inside wiring itself has a small amount of parasitic inductance, which for some purposes can be estimated at 19 nH/inch. The sum of the inductances due to the in-building wire itself can cause a substantial amount of parasitic inductance to be present on the power wires coupled to the ballast circuits. While it can be generally assumed there is a certain amount of inductance present, the actual values present in a particular instance are usually not known, because the exact value is highly dependent on the particular building and other parameters which vary from installation to installation. Thus, parasitic inductance is usually present, but the degree to which it is present is not known. The presence of this inductance can cause undesirable effects with regard to operation of a conventional dimmer with CFL of other light sources.

Further, the conventional ballast 115 typically includes a large electrolytic capacitor (not shown) that stores energy therein. The combination of the capacitance in the light ballast and the parasitic inductance in the wire can produce an adverse effect on the operation of a conventional dimming circuit with respect to the ballast and light source resulting in a phenomenon known as “line current ringing.”

During the operation of the ballast 115, the capacitor therein is charged at the beginning of every half-cycle of line voltage until its voltage is substantially equal to the voltage provided via the power source 105. However, the inductance that is activated by the turning ON of the triac results in additional energy that is converted into current that is present when the triac 130 is turned ON. This additional current causes a ringing condition in the LC circuit voltage. As a result, during the operation of the lighting system 100, the current of triac 130 can briefly reverse direction (i.e., it becomes negative) or drop to zero, or nearly zero. Because of this condition, the “ringing current” causes the triac 130 to experience little or no current flowing across its terminals, and it unlatches and temporarily turns dimmer circuit 120 OFF. In other words, the parasitic inductance in the power lines and the capacitance in the ballast form an LC circuit that is known to cause a current ringing condition at the triac.

Once the triac 130 is turned off, the light source goes off and the capacitor 140 is recharged causing the diac 150 to be retriggered. Thus, the diac 150 presents a current to the gate of the triac, thereby turning ON the triac. The ballast then functions to turn on the light source. This results in the triac (and the light source) being rapidly turned ON and OFF for the portion of a half-cycle of line voltage during which the light source should be on.

In other words, dimmer circuit 120 cause the light to blink when used in conjunction with ballast 115. Generally, the ringing current occurs several times within the first 250 microseconds after initially actuating triac 130. This causes light source 125 to exhibit a flicker that much longer and that is perceivable to the human eye. As a result of the flicker, conventional dimmer circuits are not used with conventional ballast circuits using gas discharge type light sources as their operation is annoying to the user.

This problem can be illustrated in another way using FIG. 1b, which models the typical environment in which a conventional dimmer may be used with a dimmable CFL or gas discharge light source. In FIG. 1b, the light source and ballast are modeled as a parallel R C circuit 170. This could be a CFL where the lamp and ballast are integrated, but could apply to a separate ballast and lamp (e.g., tubular fluorescent lamps with a non-integrated ballast). Recall that for incandescent lamps, they are seen as a purely resistive load to the power source, with essentially no capacitance. However, a fluorescent light and ballast presents both a capacitive and resistive load.

The conventional dimmer 180 is modeled as having a switch 182 (e.g., triac or other suitable device). There is essentially no capacitive or inductive load associated with modeling the dimmer. Finally, the infrastructure portion 160 of the building includes an AC power source 162 which can be modeled as a DC battery in this instance, since the series of very short time windows that are used to analyze the circuit makes the power source appear as a DC source. Hence, the AC power source is modeled as a DC power source and the triac is shown as a SCR, since only one current direction is involved for the narrow time window of a half cycle. The parasitic inductance of the household wiring is shown as an inductor 164.

Assuming that the dimmer 180 is OFF, then there is no current flowing through the circuit as the voltage rises at the rectified AC power source 162 (DC source). Once the dimmer 180 turns on, current flows through the circuit and the capacitor 172 is charged to the present (instantaneous) voltage. The current also creates energy stored in the inductor 164, which is the inductance in the house wiring. The combination of the voltage source and the energy stored in the inductor added together may cause the voltage across the dimmer to be actually greater than the line voltage, and this causes the dimmer to turn OFF. The voltage at the capacitor is then reduced due to the generation of light in the bulb (not shown) which is modeled as the resistor R 174, causing the voltage across the dimmer to decrease, and causing the cycle to begin over. Typically, this ON/OFF switching of the dimmer will occur several times during a half cycle.

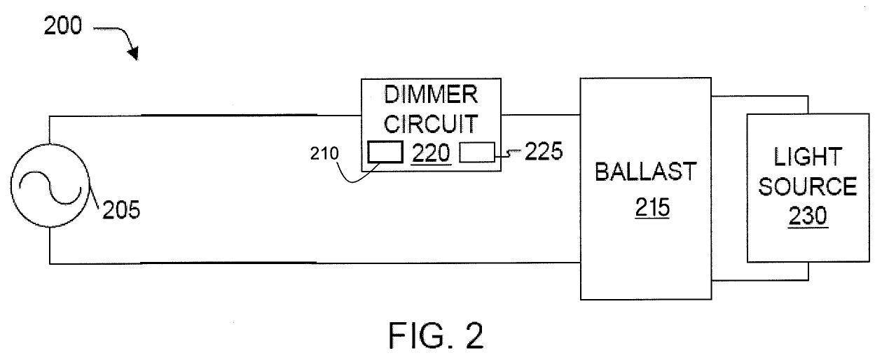

FIG. 2 illustrates one embodiment of a block diagram of a light system 200 in accordance with the present invention that implements a dimmer circuit that avoids the problem of perceivable flickering associated with prior art dimmers. In the illustrated embodiment of FIG. 2, a power source 205 (e.g., 120 VAC or 240 VAC, etc.), which typically provides voltage that alternates at a line frequency (e.g., 60 Hz in the U.S., 50 Hz in other countries, etc.), is coupled to a rectifier 210. Rectifier 210, which is coupled to a ballast 215 via a dimmer circuit 220, rectifies the line voltage of power source 205, thereby doubling the line frequency (e.g., to 120 Hz for the U.S., 100 Hz in other countries, etc.) conveyed to the dimmer circuit 220 and then the ballast 215. Dimmer circuit 220, which typically has a potentiometer configured by a user, adjustably limits the amount of energy provided to ballast 215. To prevent any perceived flickering, dimmer circuit 220 includes a charge circuit 225 to store energy therein (e.g., a voltage) to avoid the prematurely unlatching a solid state switch. Ballast 215 also passes and limits current into a light source 230 to emit light there from. The ballast 215 can be any dimmable ballast, including the circuit described in U.S. patent application Ser. No. 12/205,564, filed Sep. 5, 2008, or the circuit described in U.S. patent application Ser. No. 12/277,014, filed on Nov. 24, 2008, the contents of both of which are herein incorporated by reference in their entirety.

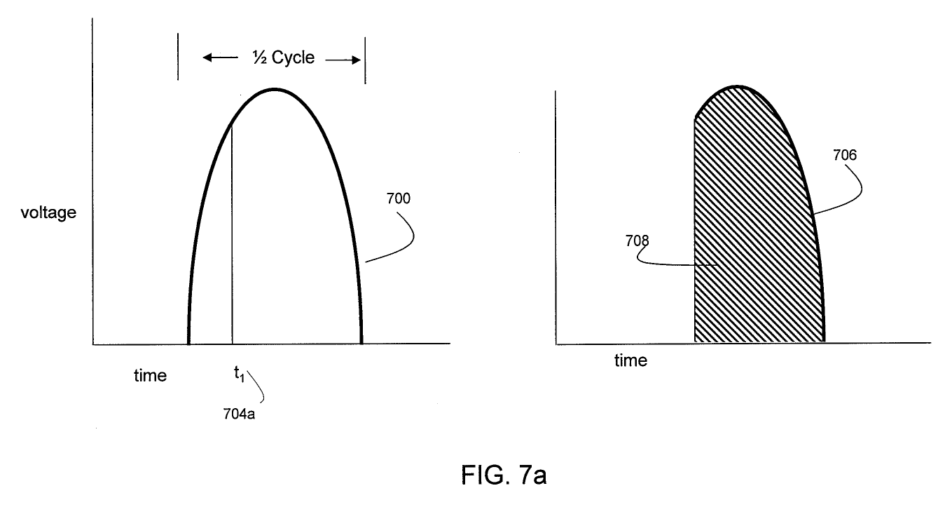

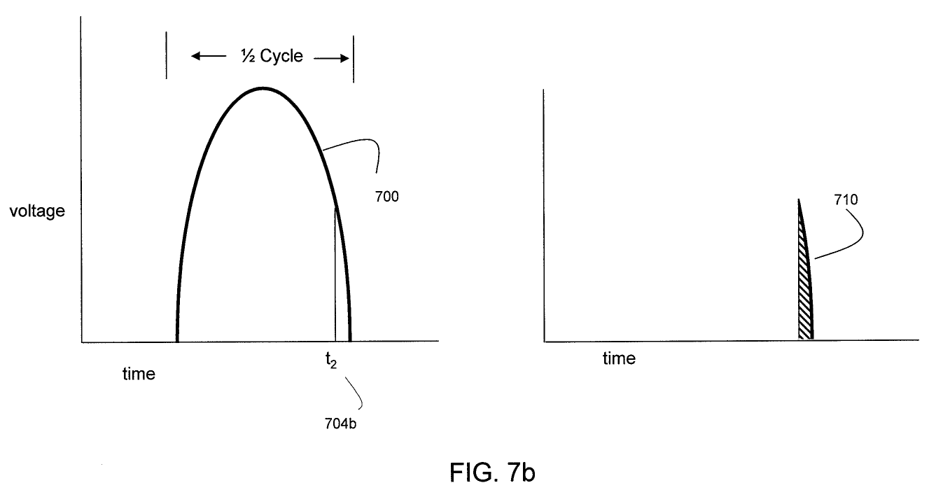

The dimmer circuit modifies the half wave voltage presented to the ballast from the power source as shown in FIG. 7a. In FIG. 7a, a voltage waveform 700 with a duration of a ½ cycle is shown based on the incoming power source (typically 60 Hz for a full cycle or 120 Hz for a half cycle). If the unmodified voltage wave is presented to the ballast, then there is no dimming. Typically during dimming, a leading portion of the voltage waveform is “sliced” based on a user-definable time, t₁ 704a. This is also known as “phase angle control.” This produces the resulting waveform 706, which is referred to herein as the “slice” of the waveform. In essence, by changing the point at which the incoming voltage is presented, the size of the slice provided to the ballast, the amount of power (and light generated) is varied. Thus, dimming is accomplished by changing the time duration defining the size of the voltage slice presented to the ballast. The shaded portion 708, which is the area under the curve, represents the energy provided to the ballast. Hence, the smaller the voltage slice, the less energy is provided to the ballast, and the less light is produced from the light source.

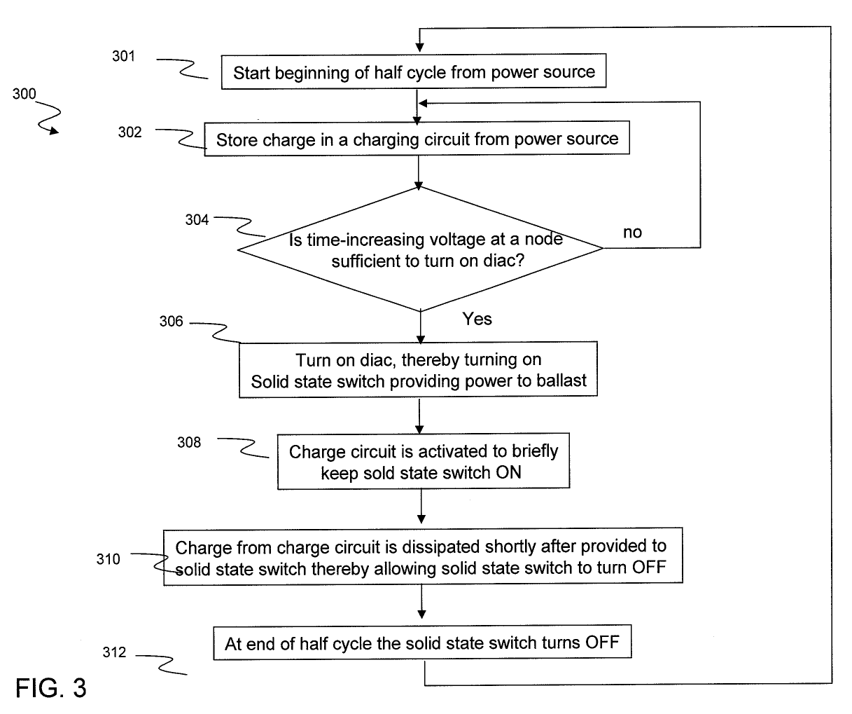

FIG. 3 illustrates an embodiment of a process 300 that dimmer circuit 220 (FIG. 2) may implement in accordance with the principles of the present invention. In particular, the operation of exemplary process 300 generates light during a portion of each half-cycle of the line voltage (e.g., which is twice the frequency of a 60 Hz source, namely 120 Hz, etc.). The process repeats for each half cycle. Exemplary process 300 begins at the beginning step 301 of a half cycle of voltage provided to the dimming circuit. The dimming circuit at step 302 stores some of the incoming energy in a charging circuit. The charging circuit comprises various elements, but for this embodiment, the charge is stored in a capacitor which is coupled to the power source, and the stored charge in the capacitor increases as the incoming voltage increases.

As the voltage increases, there is a voltage at another point, a node, which also is increasing with respect to time, although at a different rate. The rate of increase at the node is determined by a RC circuit, not directly by the input voltage. Further, the rate of increase is settable by the user altering the “R” value of the R-C ladder circuit. This is accomplished a user-settable potentiometer. Thus, the time constant of the RC circuit determines the aforementioned t₁ of FIG. 7a, which is the point in time into the half cycle when the voltage waveform from the power source is sliced and presented to the ballast. At step 304, if the voltage at this node reaches a certain threshold, (e.g. 30 volts), it will cause a diac to turn on in step 306. If the voltage does not reach the threshold, then the voltage at the node will continue to increase. During this same time, step 302 is performed, and the voltage in the charge circuit is also increasing.

Once the diac is turned ON (also referred to herein as “activated”) at step 306, the diac causes a solid state switch to turn ON, which provides the incoming voltage to the ballast. However, the possibility of a ringing current due to line inductance in the household wiring may cause the solid state switch, which can be embodied in a SCR, to turn OFF (also referred to as de-activated). In summary, the presence of additional voltage due to the parasitic inductance can cause the solid state switch to briefly encounter a decrease of current below its holding current, effectively shutting off the solid state switch. To prevent the solid state switch from prematurely shutting off, a voltage from a charge circuit is provided in step 308 to the solid state switch to keep it in an ON condition.

However, the solid state switch must be kept ON for a short duration—only long enough to prevent the ringing current from inadvertently turning the solid state switch off. In any event, the solid state switch should not be kept ON by the charge circuit past the half cycle. Thus, in step 3 10, the energy from the charge circuit is dissipated shortly after activating the solid state switch ON, which allows the solid state switch to turn OFF when the voltage across its terminals is near zero at the end of the half cycle. In other words, the charge circuit keeps the solid state switch ON for a short while after it is initially turned ON, to prevent it from prematurely turning OFF. In some embodiments, exemplary process 300 biases the switch ON at step 308 for a period of time in the range of approximately 100 to 2000 microseconds. The time period for which the switch is biased ON depends on the point (relative to the incoming voltage waveform) when the switch is initially triggered ON. Once the charge circuit is deactivated, the charge circuit does not by itself cause the solid state switch to turn OFF, but merely allows the solid state switch to turn OFF when conditions are appropriate.

In step 312 when the voltage of the half cycle nears zero, and the current through the solid state switch is near zero, the solid state switch unlatches, and turns OFF, as is desired. Because the charge circuit is no longer preventing the switch from turning OFF, and the voltage across the solid state switch is zero, the solid state switch is able to turn OFF. Thus, process 300 unlatches the switch (i.e., opens) at the end of each half-cycle of line current. At the beginning of the next half cycle, the process then repeats at step 300.

In exemplary process 300, the operation of the charge circuit keeps the solid state switch in an ON condition regardless of the load current. Thus, in the event of an operating condition such as a ringing current, which would normally otherwise cause the SCR to experience substantially no current flowing from across its terminals and thereby turning it OFF, the gate of the SCR remains biased to keep the SCR latched ON. Further, the charge circuit is operable to allow the switch to shut OFF at the end of each half-cycle of the line voltage. Accordingly, a light source connected to such a dimmer that implements exemplary process 300 would experience no perceivable flickering during its operation and would be presented with the waveform 706 of FIG. 7a.

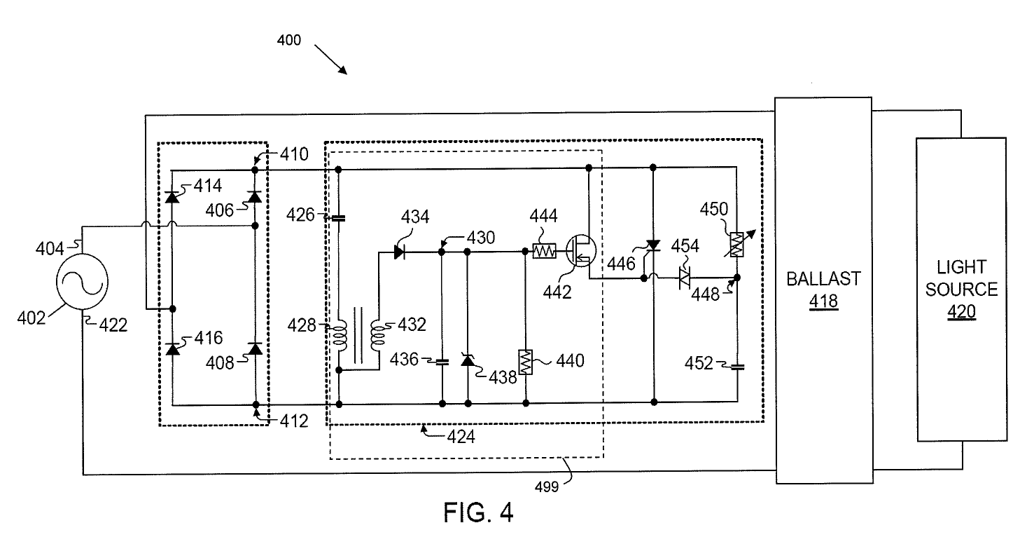

FIG. 4 is a schematic diagram of an embodiment of a system 400 that includes a dimmer that implements exemplary process 300. In the illustrated embodiment of FIG. 4, a power source 402 is connected to a rectifier via its first terminal 404. Typically, the power source is a 120 VAC 60 Hz, but could be 240 VAC 50 Hz, or other values. Thus, in other embodiments which use, for example, 400 Hz AC power sources, the principles of the present invention can be adapted to function to dim lights as well. In particular, the power source 404 is connected to the anode of a diode 406 and the cathode of a diode 408. The cathode of diode 406 is connected to a first node 410 and the anode of diode 408 is connected to a second node 412. The cathode of a diode 414 is connected to node 410 and the anode of a diode 416 is coupled to node 412. The anode of diode 414 and the cathode of diode 416 are both connected to a ballast 418, which is further coupled to a light source 420 (e.g., a gas discharge lamp, a fluorescent lamp, a LED, CFL, etc.). Ballast 418 is also connected to a second terminal 422 of power source 402. In the illustrated embodiment, diodes 406, 408, 414, and 416 form a full wave bridge rectifier, such as the rectifier 210 of FIG. 2. Other embodiments can implement the full wave bridge rectifier using a single component, which packages the separate diodes into one device.

In the illustrated embodiment of FIG. 4, nodes 410 and 412 are further connected to a dimmer circuit 424, such as dimmer circuit 220 having charge circuit 225 in the embodiment of FIG. 2. In particular, node 410 is coupled to node 412 via a capacitor 426 and a primary winding 428. Node 412 is further coupled to a third node 430 via a secondary winding 432 and a diode 434. In the illustrated embodiment, the cathode of diode 434 is connected to node 430. Further, node 430 is coupled to node 412 via a capacitor 436, a zener diode 438, and a resistor 440, each of which is configured in parallel. Node 430 is coupled to the gate of a transistor 442 via a resistor 444.

In the illustrated embodiment, transistor 442 is implemented by an N-channel metal oxide semiconductor field effect transistor (MOSFET), but transistor 442 can be implemented by any suitable solid state device (e.g., a switch, a bipolar transistor, a P-Channel MOSFET, an insulated gate bipolar transistor, HEXFET, triac, sensitive gate SCR, etc.). The drain of transistor 442 is connected to node 410 and its respective source is connected to the gate of a silicon controlled rectifier (SCR) 446. In the embodiment of FIG. 4, node 410 is also coupled to node 412 via SCR 446. In other embodiments, a triac could be substituted fro the SCR. Further, node 410 is coupled to a fourth node 448 via an adjustable resistor 450 (e.g., a potentiometer, etc.). The adjustable resistor 450 is configurable by the user and is typically a potentiometer. Node 448 is coupled to node 412 via a capacitor 452 and node 448 is further coupled to the gate of SCR 446 via a diac 454 (also, known as a four layer diode, STS, Shockely diode, sidac, etc). In other embodiments, the diac and SCR could be integrated into a common package called a quadtrac, logic triac, or alternistor triac.

The operation of the dimmer circuit 424 will be explained in conjunction with a half-cycle of the line frequency of the power source 402. In particular, the diodes 406, 408, 414, and 416 allow a line voltage to be present to the dimmer circuit 424 via node 410. Initially, the only current flowing from node 410 to 412 is due to current flowing through the adjustable resistor 450 and capacitor 452, and current through capacitor 426 in series with winding 428. However, although capacitor 426 stores energy at a voltage, it is of a small enough value that it does not effect the RC time constant of potentiometer 450 and capacitor 452. The adjustable resistor 450 and capacitor 452 increase the voltage at node 448 at a rate that is determined by the resistance value of the adjustable resistor 450, which is typically selected by a user. After a delay based in part on the value of adjustable resistor 450, the voltage at node 448 exceeds a threshold voltage associated with diac 454. As a result, diac 454 enters what is commonly referred to as a “breakdown” mode and allows current to flow through its respective terminals. In response, current flows into the gate of SCR 446, which causes SCR 446 to latch ON and couple node 410 to node 412 via a low impedance path. SCR 446 is latched ON, thereby causing its respective gate to lose control over its operation. SCR 446 remains latched ON until it experiences an operating condition causing it to unlatch, which is typically when the current flowing through its respective terminals is below its holding current. In this embodiment, the components comprising diac 454, adjustable resistor 450, and capacitor 452 comprise the “bias circuit” as these component initially bias the SCR into an ON condition. Other components can be used to construct a biasing circuit.

There is a nominal amount of current required to run the ballast. When the SCR turns ON, there is an excessive amount of current that rings in flowing from node 410 to 412. By “ringing” this means that there is a current peak above the nominal amount of current (thereby adding to the nominal current) and an amount less than the nominal current amount (thereby subtracting from the nominal current). When current level subtracts from the nominal amount, this can cause the current through the SCR to drop below the holding current level, causing to turn off. The current added to the nominal amount is due to the parasitic inductance in the power line wiring, which is produced when the SCR turns on. Thus, a higher than normal current is provided to the ballast, which then reduces in level causing the current in the SCR drops to zero or near zero, resulting in the aforementioned ringing condition causing the SCR to turn OFF.

This undesirable condition is addressed in one embodiment by the charge circuit which comprises the component shown within the dotted line 499 in FIG. 4. The charge circuit ensures that the SCR does not inadvertently turn OFF during the current ringing condition. The operation of the charge circuit is now discussed.

When current begins to flow through SCR 446 (e.g., when SCR 446 is ON or activated), capacitor 426 discharges the energy stored therein as a current flowing through the primary winding 428, which induces a voltage in the secondary winding 432 that turns into a current causing the charging of capacitor 436. The transformer in this embodiment is a non-gapped, wound transformer, double E core, with a 4 to 1 turn ratio, and having a 10 micro-second hold up time at 50 volts. However, other configurations having similar functional properties can be used, as will be discussed below. In particular, primary and secondary windings 428 and 432 cause node 430 to have a voltage, but the voltage at node 430 is configured to not exceed the voltage at node 410 by means of zener diode 438. In this embodiment, the transformer can be viewed as a voltage transformer, where the voltage generated by the transformer is determined by the voltage associated with capacitor 426. As will be described in detail below, because node 410 is connected to power source 402, the voltage at node 430 is reduced because of the step-down of the transformer. This voltage at node 430 bias transistor 442 such that it supplied gate current to SCR 446 to prevent it from unlatching (i.e., turning OFF).

The amount of energy discharged by capacitor 426 depends on the amount of energy stored therein. Recall that the discharging of the capacitor is caused by the triggering of SCR 446, and thus the amount of energy stored in the capacitor is a function of when the SCR is triggered. Thus, the amount of energy stored (and discharged) depends on the relative time when the SCR 446 is triggered. For example, if the SCR is triggered shortly after the incoming line voltage increases above zero, (such as corresponding to time t₁ in FIG. 7a) there will be less energy stored in the capacitor compared to the point in time where the SCR is triggered later within the waveform (such as, 2×t₁ or twice the time period of t₁ which would be approximately at the peak of the voltage waveform). However, if the SCR is triggered later in the half cycle (e.g., on the “down-side” of the incoming voltage waveform), there is less energy stored in the capacitor compared to the middle of the waveform. This means that the charging circuit keeps the SCR latched ON for a shorter time period, which is appropriate to prevent the SCR from being latched after the end of the half cycle.

In the illustrated embodiment, the voltage from the secondary winding 432 causes a charge to be stored in capacitor 436, thereby causing node 430 to have a voltage present. Further, diode 434 prevents the charge in capacitor 436 from discharging backing into the winding 432. However, if the voltage at node 430 exceeds a breakdown voltage associated with zener diode 438, zener diode 438 enters what is commonly referred to as the “avalanche breakdown mode” and allows current to flow from its cathode to its anode (i.e., into node 412). Once the voltage at node 430 does not exceed the breakdown voltage, the zener diode 438 recovers and prevents current from flowing into node 412. Stated differently, the zener diode 438 limits the voltage stored in the capacitor 436 so that its voltage does not exceed a predetermined threshold. While the zener diode could be omitted, it provides a safety mechanism to avoid damage to the FET 442.

Resistor 440 cause capacitor 436 to dissipate the energy stored therein at a predetermined time. Resistor 440 ensures that the energy in capacitor 436 will dissipate so capacitor 436 does not keep transistor 442 ON (and thereby keeping the SCR 446 ON) longer than desired. Resistor 444 is used as a current limiter if a bi-polar transistor is used and to prevent parasitic oscillation conditions if a MOSFET is used. The transistor 442 should only keep the SCR ON for a short duration so that the SCR is not turned OFF due to the ringing current, and certainly the SCR should not be kept ON past the duration of the half cycle. In particular, resistors 440 and 444 are configured to cause transistor 442 to have a gate-source voltage thereby turning ON and causing the gate of SCR 446 to have a gate-cathode current resulting from on the charge stored in capacitor 436. Stated differently, resistors 440 and 444 keep the gate of SCR 446 energized only for a period of time based on the amount of charge stored in capacitor 436. In the illustrated embodiment, zener diode 438, capacitor 436, and resistors 440 and 444 are configured to bias the gate of SCR 446 by way of transistor 442 for a period of time approximately in the range of 100 to 2000 microseconds. The duration of the biasing of SCR 446 by transistor 442 depends on the amount of energy stored in capacitor 436, which is charged from the energy stored in capacitor 426. Thus, the point in time relative to the input voltage waveform when the SCR is triggered impacts how long the SCR will be biased by the charge circuit. The biasing duration is also limited by the zener diode 438 and the resistor 440. Consequently, the charge circuit 499 biases SCR 446 for a short portion of each half-cycle of the line voltage and allows the SCR to unlatch itself at the end of each half-cycle. Although the biasing duration is variable, it is long enough (e.g., typically in the range of 100-2000 microseconds) to ensure that the SCR remains ON, but is not kept on past the end half cycle. The charge circuit provides a current through the gate to turn the SCR ON only when the SCR is OFF. That is, the charge circuit is configured to provide a biasing current to the SCR during the required time period when it is OFF, but no current is required if the SCR is latched ON. It is only when a ringing current condition exists that the SCR may become unlatched, and that is typically when the charging current provides current to turn the SCR back ON.

As described above, if driving a capacitive load such as an electronic ballast, the parasitic impedance in the wiring of a building may cause SCR 446 to experience a ringing current, which may cause the current flowing through the SCR 446 to be less than its holding current. In other words, SCR 446 may experience the operating condition that may cause it to unlatch prematurely. If so, then at the same time, current will begin to flow through adjustable resistor 450 and the capacitor 452, which will cause the diac 454 to retrigger. Thus, this will result in a flickering condition of the light source. However, as described above, capacitor 436 stores a charge in response to SCR 446 being turned ON, which causes the transistor 442 to have a gate-source voltage. As a result of the gate-source voltage of transistor 442, SCR 446 has a gate current due to the load current that was through the SCR and remains latched ON for substantially the same duration that transistor 442 is turned ON. That is, when SCR 446 is turned ON, it receives a current to prevent it from becoming unlatched as a result of the ringing current. As a result, the light source 420 does not flicker during the operation of each half-cycle of the line current.

FIG. 4 does not illustrate any sort of noise filter, and it is possible to place a noise filter on the output of the rectifier between diodes and the SCR, to prevent noise from being introduced back into the power source 402. This filters lowers noise by lowering the di/dt caused by ringing current.

FIG. 4 is unusual relative to the prior art in that it connects an SCR across the output terminals of a full wave bridge rectifier. This configuration is sometimes referred to a “shorted bridge” configuration. In most cases, a triac, or two SCRs connected back-to-back (“an anti-parallel configuration”) are used in lieu of a shorted bridge. However, the use of a single SCR is unconventional, because it was commonly thought using an SCR in a shorted bridge configuration would result in the SCR latching permanently in the ON condition, and therefore negate its usefulness in dimmer applications. Thus, generally, SCRs are not used in phase control dimmer circuits in shorted bridge configurations. Further, the holding current of an SCR is much lower than a triac (five to ten times less), which is an important parameter in dimming low level loads, such as when dimming LEDs and CFL lighting sources, which have lower current loads than incandescent lighting loads.

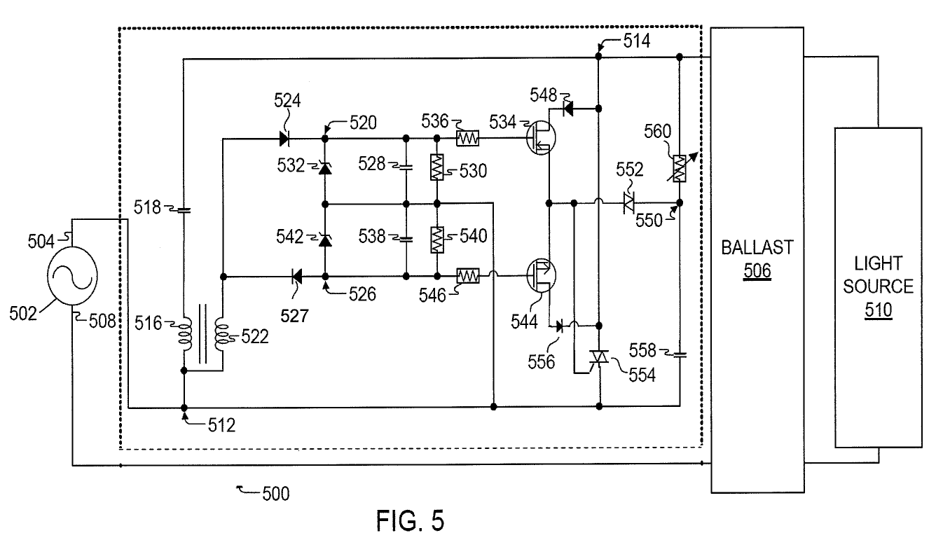

FIG. 5 illustrates another embodiment of a circuit 500 that may implement process 300. In this embodiment, there is no full wave rectifier bridge connected to the power source. Rather, each positive and negative half of the voltage cycle is processed by similar, but separate circuits.

In the embodiment of FIG. 5, a power source 502 is coupled to exemplary circuit 500 via its respective first terminal 504. In particular, the power source 502 is coupled to a ballast 506 via exemplary circuit 500. Further, exemplary circuit 500 is also connected to a second terminal 508 of power source 502. Ballast 506 is connected to a light source 510 to emit light there from. Because the power source is not rectified, the voltage is a full sinusoidal wave at node 512 at the line frequency.

The first terminal 504 of power source 502 is connected to a first node 512, which is further coupled to a second node 514 via a primary winding 516 and a capacitor 518. Node 512 is further coupled to a second node 520 via a secondary winding 522 and a diode 524. In particular, the cathode of diode 524 is connected to node 520 and its respective anode is connected to secondary winding 522. In addition, node 512 is coupled to node 526 via secondary winding 522 and a diode 527, which has its respective anode connected to node 526 and its cathode connected to secondary winding 522.

Node 520 is also coupled to node 512 via capacitor 528 and resistor 530, which are configured in parallel. Further, node 520 is also connected to the cathode of a zener diode 532, which is coupled to node 512 via its respective anode. Further still, node 520 is also coupled to the gate of a transistor 534 via a resistor 536. In the embodiment of FIG. 5, node 526 is coupled to node 512 via a capacitor 538 and a resistor 540, which are configured in parallel. In addition, node 526 is connected to the anode of a zener diode 542, which is coupled to node 512 via its respective cathode. Node 526 is also coupled to the gate of a transistor 544 via a resistor 546. In the illustrated embodiment of FIG. 5, transistor 534 is implemented by an N-Channel MOSFET and transistor 544 is implemented by a P-Channel MOSFET. Of course, transistors 534 and 544 can be implemented by any suitable device (e.g., bipolar transistors, HEXFET, etc.).

The drain of transistor 534 is coupled to node 514 via a diode 548. In particular, the anode of diode 548 is connected to node 514 and its respective cathode is connected to the drain of transistor 534. The source of transistor 534 is connected to the source of transistor 544, both of which have their respective sources that are further coupled to a node 550 via a diac 552. In addition, the sources of transistors 534 and 544 are connected to the gate of a triac 554. The drain of transistor 544 is coupled to node 514 via a diode 556. In particular, the cathode of diode 556 is connected to node 514 and its respective anode is connected to the drain of transistor 544.

In the illustrated embodiment of FIG. 5, node 512 is coupled to node 514 via the main terminals of triac 554. Node 512 is also coupled to node 550 via a capacitor 558 and node 550 is further coupled to node 514 via an adjustable resistor 560 (e.g., a potentiometer, etc.). In particular, resistor 560 is adjustable by a user and is operable to selectively allow energy to be provided through exemplary circuit 500 to cause light source 510 to emit light there from. In the illustrated embodiment, node 514 is further connected to ballast 506.

In the illustrated embodiment of FIG. 5, exemplary circuit 500 operates in a manner similar to the description of FIG. 4. In particular, the adjustable resistor 560 and capacitor 558 form a RC circuit having a time constant and is adjustable based on the resistance of the resistor 560. Initially, the capacitor 518 stores an amount of charge when the SCR 554 is turned OFF. When the voltage at node 550 exceeds a threshold voltage associated with the diac 552 (e.g., ±30 volts, etc.), current flows into the gate of SCR 554 to latch it ON, thereby forming a low impedance path from node 512 to node 514. In response, the capacitor 518 releases the energy stored as a current, which induces a current in the secondary winding 522.

If the current generated by the secondary winding 522 is negative, a current flows into node 526 and capacitor 538 stores the current as a voltage. However, zener diode 542 limits the voltage across capacitor 538. As a result of the voltage, the resistors 540 and 546 cause a predicated amount of current to flow into node 512. The resistors 540 and 546 are configured to limit the amount of current. As a result, a voltage is generated and causes transistor 544 to have a gate-source voltage, thereby turning ON transistor 544. However, because the resistors 540 and 546 limit the current, transistor 544 is turned ON for a period of time after SCR 554 latches ON. In some embodiments, the transistor 544 is operable for a range of approximately 100 to 1000 microseconds. As a result of turning ON transistor 544, triac 554 continues to have a gate current, thereby ensuring the triac 554 is latched for a period of time after turning ON.

On the other hand, if the current generated from secondary winding 522 is positive, a current flows into node 520 via diode 524. The current is stored as a charge in the capacitor 528 as a voltage; however, zener diode 532 limits the voltage stored therein. As a result of the voltage, the resistors 530 and 536 cause a predicable amount of current to flow into node 512. The resistors 530 and 536 are configured to limit the amount of current. In response to the current, a voltage is generated and causes transistor 534 to have a gate-source voltage, thereby turning it ON. However, because resistors 530 and 536 limit the current, transistor 534 is turned ON for a period of time once triac 554 is latched ON (e.g., typically between 100 microseconds-1000 microseconds). As a result of turning ON transistor 534, triac 554 continues to have a gate current thereby ensuring the triac 554 is latched for a period of time after turning ON.

In the embodiment of FIG. 5, exemplary circuit 500 is operable to allow current to flow in both directions across triac 554, which remains latched during both the positive half-cycle of the line current and the negative half-cycle of the line current. As a result, exemplary circuit 500 does not require a rectifier. On the other hand, in the embodiment of FIG. 4, the dimmer circuit 424 requires fewer components by implementing a rectifier and allowing current to flow in only one direction across the SCR 446.

FIG. 5 does not illustrate any sort of noise filter. It may be possible to add a small value inductor to the AC line, but doing so contributes to the current ringing problem. Any such inductance would be of a value, such that any ringing would be dissipated before the RC time constant expires of capacitor 528 and resistor 530 (or 538 and 540). Alternatively, the presence of a small resistor in the ballast circuit may function to reduce noise from ringing. The circuit of FIG. 5 can be easily adapted to 240 volt operation.

In the described embodiments, a dimmer circuit is provided that is able to dim light sources operating with a ballast having a capacitive load without noticeable flicker. Further, the dimmer circuit is capable of operating with any type of light source (e.g., incandescent bulbs, gas discharge lamps, LEDs, etc.) over the wide range of light output (e.g., from 20% to 100%) and for a variety of power loads. The dimmer circuit can be easily implemented into existing manufacturing processes without substantial additional costs. In addition, the dimmer circuit is capable of handling lower current, approximately in the range of 10 to 20 milliamps, thereby allowing the ballast to function with a single dimmable CFL. As a result, the described embodiments above are capable of handling low power light sources such CFLs.

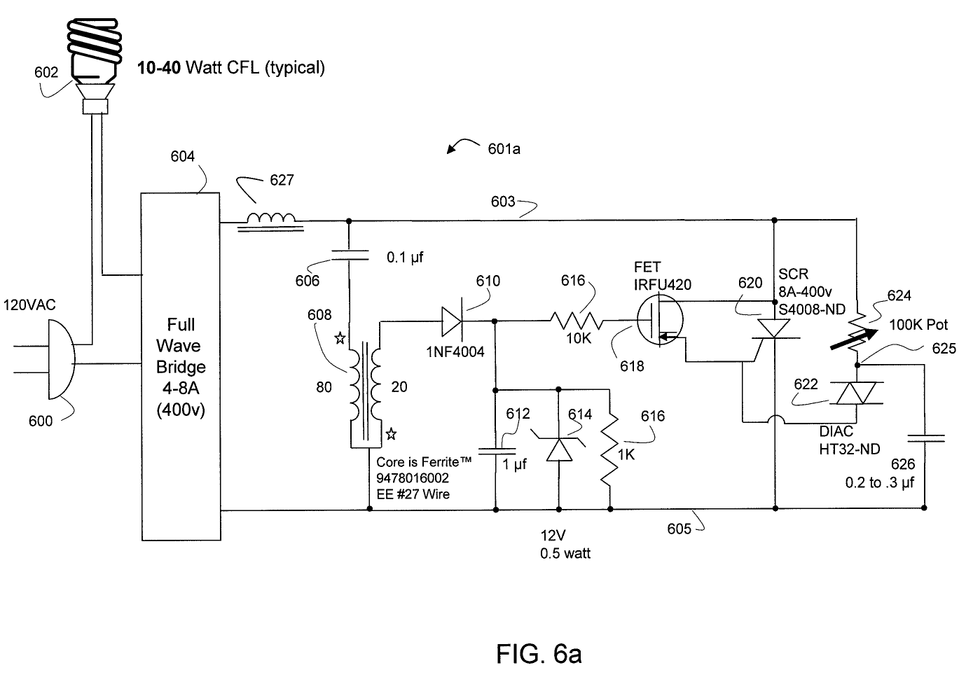

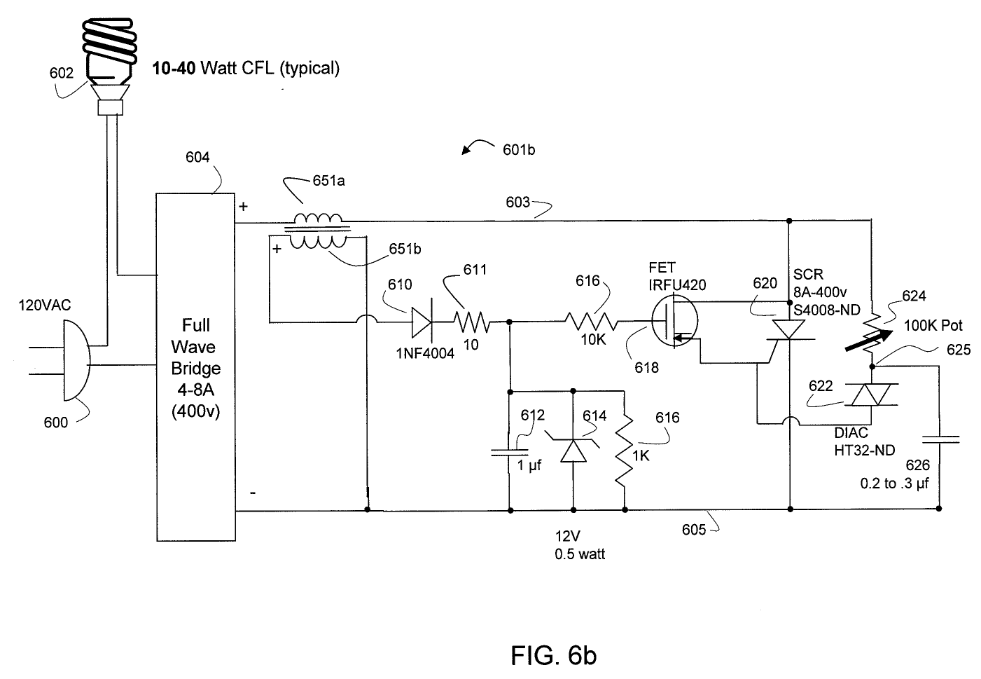

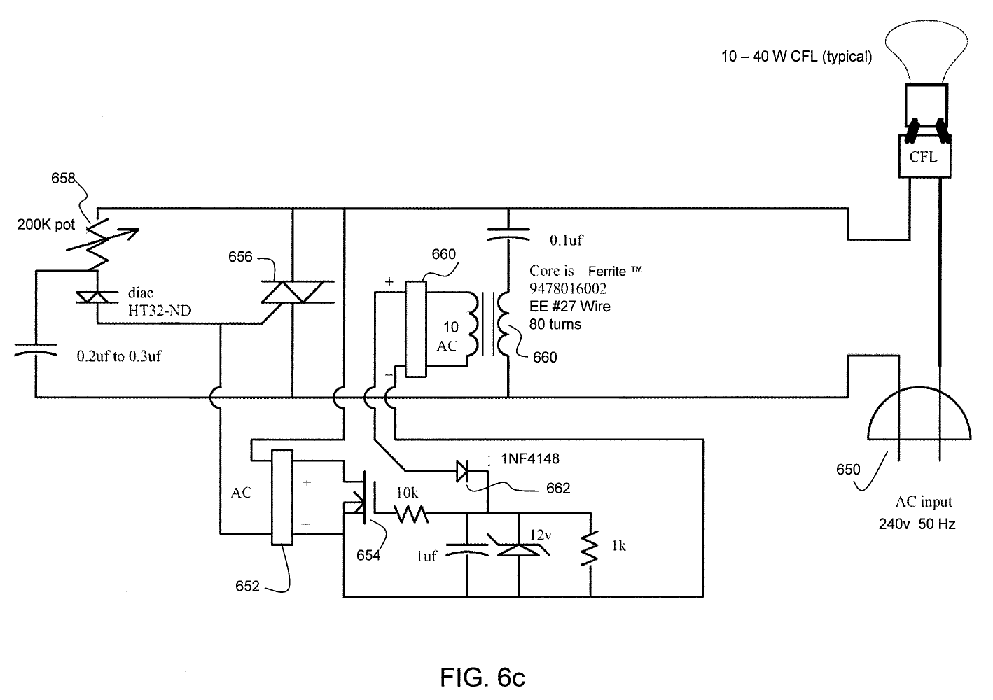

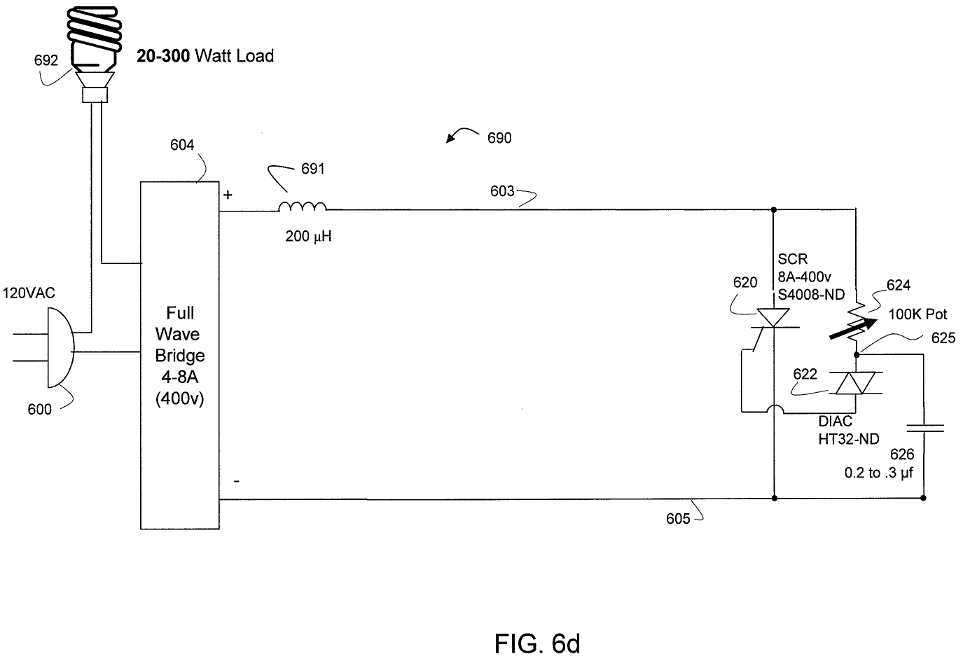

FIG. 6a is an illustration of another embodiment of the invention as used for dimming a conventional CFL, typically in the 10-40 watt range. The diagram illustrated in FIG. 6a is similar in various respects to the diagram of FIG. 4. However, in FIG. 6a, a conventional CFL 602 (typically in the range of 10-40 watts) is dimmed using the circuit 601a. Because the conventional CFL incorporates an integrated ballast and light source, there is no separate ballast identified in FIG. 6a. Although a single CFL is illustrated, the dimmer circuit as illustrated can dim multiple CFL (or other loads) up to 300 watts. By reducing the value of the inductor 627, and replacing other components with appropriate higher ratings, one skilled in the art can adapt the embodiment of FIG. 6a to dim higher wattage loads. This embodiment would also function with linear fluorescent bulbs operating with a separate ballast.

In FIG. 6a, the theory of operation is similar to that as described for FIG. 4. A full wave bridge rectifier 604 receives household power at 120 VAC and at 60 Hz. The full wave bridge rectifier is depicted here as an integrated unit, although it could be made from individual diodes, as shown in FIG. 4. The frequency output of the rectifier is determined by the input line frequency (at 60 Hz, the half cycles would be at 120 Hz). The output voltage appears on node 603. Whether any current flows from node 603 to node 605 is determined by the latching status of SCR 620, which in one embodiment is rated at 8 amps, 400 v, with a holding current of 30 ma. Further, the point at which the SCR conducts is determined by resistor 624, which is a 100 K potentiometer settable by the user, and capacitor 626, which is 0.2 to 0.3 μf capacitor. This RC combination causes the voltage at node 625 to increase at a give rate, which at a certain threshold (30 volts in one embodiment), causes the DIAC 622 to breakdown, thereby causing the SCR 620 to latch, thus allowing current to flow through the SCR terminals. The DIAC in this embodiment is a four layer diode, with a trigger voltage of approximately 30 volts. The current from diac flows into the gate of the SCR, which causes the SCR to latch “ON.” Thus, current flows from node 603 to node 605.

As the current flows across the SCR, capacitor 606, which is a 0.1 μf capacitor, causes the charge to be transferred at a voltage into the transformer 608 and then into capacitor 612. This transformer in this embodiment can be viewed as functioning as a voltage transformer. The transformer can be made using a Ferrite Core No. 9478016002, using #27 wire, where the primary has 80 turns, and the secondary has 20 turns. The presence of current on the primary winding induces a current on the secondary windings, causing a voltage to appear at the cathode of diode 610 and the energy is stored in capacitor 612. Diode 610 is a conventional INF4004 diode and prevents any current from flowing back into the transformer.

The zener diode 614 is rated at 12 volts and 0.5 watt, and prevents the voltage at the cathode of diode 610 from exceeding 12 volts due to the release of energy from capacitor 612 through resistor 616. Resistor 616 has a 1K value and resistor 616, which is a value of 10K. The presence of the voltage at the resistors causes the transistor 618 to have a gate-source voltage, which turns the transistor 618 ON. The transistor in this embodiment is a FET IRFU420 from International Rectifier™. This transistor causes the SCR's gate to be energized, and keeps the SCR from turning off.

As noted previously, the DIAC turns “ON” the SCR at a delayed point relative to the start of each half cycle. The time at which this occurs is determined by the RC value of capacitor 626 and resistor 624. Since resistor 624 is a user-settable potentiometer, the time value varies based on the user's setting. The varying delay at which the DIAC turns the SCR ON determines the energy delivered to the CFL, and therefore determines the light produced.

FIG. 6a also includes a line filter 627, which may be present in a commercial embodiment of the invention. The line filter, embodied as an inductor, lowers the di/dt of the current thereby reducing the high frequency electrical noise being introduced back into the power lines. Because of the potential proliferation of dimmers, such noise limiting inductors (or other equivalent circuitry) are used to avoid introducing noise on the power line infrastructure, whether it be in the building where the dimmer is being used, or otherwise. Because the noise filter reduces the change in current (e.g., di/dt), it by itself can be used in some embodiment (as discussed below) to facilitate the current ringing problems.

FIG. 6b is another embodiment, which is similar in concept to FIG. 6a, which again is similar to FIG. 4. This embodiment also is designed to be used with a CFL having an integrated ballast, although it can be used with other types of light sources. This embodiment uses a different structure for providing energy to the charge circuit. Unlike FIG. 6a, which used a capacitor 606 in series with transformer 608 to provide current through the diode 610, the embodiment in FIG. 6b uses a inductor having a primary winding 65 la and a secondary winding 651b. The primary winding 651a functions as an noise filter just as inductor 627 does in FIG. 6a. However, the secondary winding which is coupled to the primary winding (similar to a transformer) functions similar to the transformer 608 in FIG. 6a. Thus, when SCR 620 is turned ON by the diac, current flows through the primary winding of inductor 651a inducing a voltage in the other winding 651b, which in turn causes the energy to charge capacitor 612 via diode 610 and resistor 611. In this embodiment, the transformer can be viewed as a current transformer which pushes a charge into capacitor 612 and also acts as a filter. The remainder of the circuit's operation is similar to that as described previously.

FIG. 6c is another embodiment, which is similar in concept to FIG. 6a, which again is similar to FIG. 4. This embodiment also is designed to be used with a CFL having an integrated ballast, but again can be used with other types of light sources. In FIG. 6c, the embodiment is designed for operation with a 240 volt AC, 50 Hz, power source as depicted by the plug 650. Hence, such a design would be appropriate for certain European and Asian countries which operate at this voltage and frequency. Other power sources may be used, such those that operate at 208 v AC 60 Hz, or other variations, which are typically greater than 200 volts AC. Many of the component values are similar or the same and one skilled in the art would readily recognize that the certain components would have to be adapted for the higher voltage. For example, the full wave bridge rectifier 652 would have a higher rating, such as 600 v, compared to applications defined for 120 VAC. In addition, the transistor 654 must accommodate the higher voltage. In this embodiment, a triac 656 is used instead of an SCR, and the triac 656 would have to be rated to accommodate a higher operating voltage, such as 600 v. The potentiometer 658 would require twice the resistance, namely up to 200K. Finally, the transformer 660 would require 10 turns on the secondary winding. The operation of this circuit is similar to that described for FIG. 6a. A bridge rectifier 652 is used to trigger the triac bidrectionally from a unidirectional signal from the FET 654. The above circuit could be adapted for 120V AC operation by changing the transformer turns ration to 4:1 instead of 8:1, and using a 100K potentiometer. If the full wave bridge 660 comprises standard recovery diodes, then diode 662 may be added, which is a ‘fast’ diode.

FIG. 6d is another embodiment, which includes a subset of the components shown in embodiments illustrated in FIG. 6a and FIG. 6b. This embodiment uses a SCR 620 as before, which is activated by current provided by DIAC 622. In turn, DIAC 622 is activated when the voltage at node 625 reaches a threshold voltage.

As noted previously, the SCR 620 can be de-activated, or turned OFF, by the presence of a ringing current due to inductance in the power lines, which the full wave bridge processes into a ringing current present on node 603 when SCR 620 is turned ON. In the alternative embodiment shown in FIG. 6d, the value of the inductor 691 is selected so as to not only perform the function of filtering noise preventing from being introduced back into the power line network, but it also prevents the presence of the ringing current on node 603. This is accomplished because inductor 691 stretches the current pulse, which prevent the SCR from unlatching. The inductor in one embodiment has a value of approximately 200 micro Henries (μH). This value is sufficient to prevent a ringing current for about 200 microseconds after the SCR 620 has been turned on. The value of the inductor is such that successful operation is possible for loads greater than 20 watts. Thus, the load shown in FIG. 6d is illustrated as a CFL light 692, in a range of 20-50 watts, although a single CFL is typically 42 watts or less. The present embodiment will also dim incandescent lighting loads as well. However, the potential of current ringing causing flickering in fluorescent lights is obviously inapplicable if only incandescent light sources are used.

The inductor in this embodiment preferably comprises #21 wire turned around a powered iron core, such as an E75-26 core available from Micrometals™. For applications supporting a low power load (e.g., less than 20 watts), the SCR could become unlatched, and cause flickering. This can be avoided by using a SCR with a lower holding current, such as those readily available having a 6-8 ma holding current.

As shown in FIG. 7a, the voltage for a initial half-cycle is shown as line 700. Although this diagram is discussed in the context of the circuit of FIG. 6a, which incorporates a rectifier, the first half cycle of FIG. 7a is the same regardless of whether or not a rectifier is incorporated in the embodiment. Specifically, if a rectifier is incorporated, then the next half cycle of the voltage waveform is rectified (e.g., a positive value) and looks similar to line 700. If a rectifier is not incorporated, then the next half cycle is not rectified, and is negative (not shown). The ½ cycle is 100 Hz if the power source is operating at 50 Hz, or 120 Hz if the power source is operating at 60 Hz, depending on what power characteristics are provided.

The RC value (based on the adjustable potentiometer) discussed previously defines the time value or delay at which the diac reaches the threshold voltage, and thus turns on the SCR. In FIG. 7a, the time value t₁ 704a is shown relative to the half cycle. If the value t₁ is reached early on in the half cycle, the SCR is turned ON for the remainder of the half cycle, producing a block of energy denoted separately as the area 708 under the curve 706. The area under the curve 708 corresponds to the energy provided to the ballast, and hence determines the light produced by the light source. On the other hand, if the user adjusts the potentiometer to have a longer time value, the result is that the SCR is turned on at a later time. In FIG. 7b, this is shown as occurring at t₂ 704b, which results in a smaller amount of energy provided to the ballast, depicted separately as area 7 10. The greater the energy provided to the CFL (or ballast and lamp source), the greater the luminance generated by the lamp. Thus, the energy associated with area 710 in FIG. 7b results in less light relative to FIG. 7a, which is consistent with a ‘dimmed’ condition of the light source. Subsequently voltage waveforms would be similar in shape as discussed above, but may be negative if no rectifier is present.

The above dimmer can be manufactured to be contained in a conventional dimmer switch housing with a shape and size allowing it to be installed in a conventional single gang work box (i.e., the box used in construction to contain electrical switches). This allows the dimmer switch to be retrofitted into existing residential or commercial applications, as well as for new construction. The embodiments of the dimmer disclosed herein can accommodate lighting load applications of 5-300 watts, and different component values may be scaled for higher (e.g., 300+) wattage applications. Such values for higher wattage applications can be readily determined by one skilled in the art. Such applications include dimming single fixture lighting sources, or a plurality of lighting sources controlled by a single dimmer. Further, the aforementioned dimmer can function with a variety of lighting technologies and provide flicker-free dimming over a wide range of luminescent output of the lamp. Further, multiple light sources can be dimmed using a single dimmer.

The dimmer described herein has an additional advantage of effecting a linear or approximately linear dimming response as the dimmer switch is operated, and can dim certain dimmable CFLs down to as low as 20% of maximum luminous intensity. Further, the dimmer can effectively dim lighting loads having a lower power load than prior art dimmers, which often do not function well with low wattage CFL bulbs. The present dimmer is particularly well suited for dimmable low wattage LED based lights. These features are improvements over many commercially marketed dimmer circuits for CFL bulbs. Further, the dimmer contains no programmed microprocessor. The advantages of this dimmer potentially lead to wider use of energy-saving CFL bulbs, and further save energy by allowing more CFL bulbs to be operated at reduced energy consumption.

In the above embodiment, a potentiometer in the disclosed circuit that determines the light output is operated by a user. The user varies the potentiometer setting to obtain the light output as desired. In other embodiments, the dimmer may be incorporated into a system where the value of the resistance is controlled automatically by an additional circuit or the time which the diac is turned on is otherwise determined.

The resistance value itself, or the RC time constant formed by the combination of the resistance and capacitance values, may be adjusted based on various conditions. For example, the dimmer circuit can be incorporated with a motion detector, which can be embodied in a night-time security light. Such devices commonly control outdoor lighting, and upon detecting motion, turn on a security light. Such a device may incorporate multiple light output levels. For example, at night and when motion is not detected, the lights can be dimmed to a certain level (e.g., 50%) to provide a low level security light. When the motion detector detects motion, the light is then turned on to full power, often for a limited time period after which no further motion is detected. After the limited time period expires, the light returns to the lower level. At dawn, the light is then completely turned off. In such embodiments, a control circuit would determine when the diac turns on to cause the partial light level in the absence of motion, and change the time when the diac turns the SCR on (or the time delay caused by the RC time constant) based on when motion is detected such that full light is produced. Such circuits are well known to those skilled in the art, and can be found, for example, in U.S. Pat. No. 7,164,238, the contents of which is incorporated by reference.

In other embodiments, the time delay and dimming level may be varied by other means. Continuing with the security example, a photocell could measure ambient darkness for controlling the security light. Such a circuit would cause the security light to be activated, initially at a very low light output level. As darkness increases, as detected by the photocell, a commensurate change in the time delay would occur so as to cause the light to gradually increase its output. This would avoid turning on the lamp at full power, when full power may not be initially required based on ambient conditions. In other embodiments, a microprocessor can be programmed to cause the light power to gradually increase over a set time period by changing the time delay according to its program.

Such arrangements are used for “daylight harvesting.” Daylight harvesting is another approach for conserving energy usage which involves dimming lights. One application is in an office environment, where it is common for offices on a given floor to have different directional exposures (e.g., south, north, east and west). If an office has an eastern exposure, light fixtures in that office may be coupled with a light sensor to detect ambient lighting conditions which are processed by a microcontroller. The controller then determines which lights to dim and when. The selective dimming of various lights can be used to “balance” or average the light in a work environment by dimming lights adjacent to a window having, for example, an eastern exposure in the early morning (when the morning light is brighter). Further, the present dimmer circuit can be used by a controller to change dimming levels at a slow pace such that the change in light output is hardly perceived by the occupants, and does not cause the light to blink. Thus, the dimmer circuit may be coupled with processors, timers, light detectors, motion detectors, and/or other circuitry in various ways to efficiently dim a lighting source as needed.

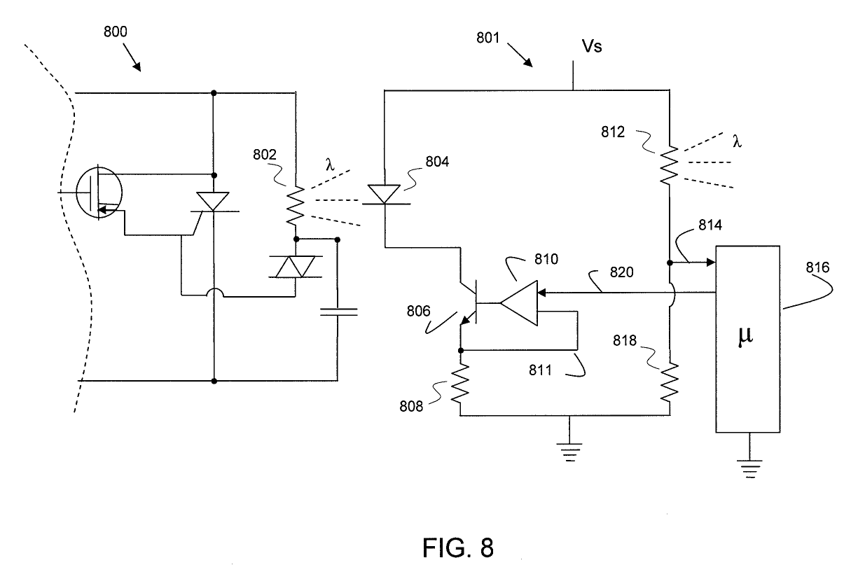

One embodiment of a light harvesting system is shown in FIG. 8. In FIG. 8, there are two main portions of the system. The first portion 800 is based on the previous embodiments (see, e.g., FIG. 6a) and only discloses a portion of the previous embodiment. In this case, the adjustable resistor 624 of FIG. 6a has been replaced with a photo-sensitive resistor 802. This device alters its resistance based on the amount of light detected by it. The second portion 801 of the system detects the ambient light and controls the resistance of the photo-sensitive resistor 802, such as cadmium-sulfide cells well known to those skilled in the art. The control of the photo-resistor is accomplished by using a LED 804. Thus, based on the amount of light generated by the LED, the resistance of the photo-resistor 802 is changed, and impacts the RC constant and dimming level as discussed earlier. One advantage of this embodiment is that the photo-resistor 802/LED 804 combination functions as an opto-isolator between the first portion 800 and the second portion 801. Further, such opto-isolators are readily available as an integrated unit.

The second portion detects the ambient light conditions via a photo-resistor 812, which is placed to detect the desired ambient light conditions as appropriate. The photo-resistor 812 and a second resistor 818 form a voltage ladder, such that an input 814 measurement voltage changes according to the light conditions. The input is provided to a microprocessor or microcontroller which is able to convert the analog voltage reading to a digital value and process it according to its program. The controller 816 is programmed to effect the desired operation.

The controller 816, based on the input voltage reading 814 then adjusts an analog output 820. The output is provided to an operational amplifier 810 which drives a transistor 806. When the transistor 806 is turned ON, current flows from the LED 804 through the transistor 806 and is limited by resistor 808. Thus, based on the level of the current passing through the LED, the light level and therefore the resistance of the photo-resistor 802 can be changed by the controller 816. In this manner, the controller can be programmed to dim a light (or series of lights) controlled by the dimmer, based on detected ambient light conditions. Similarly, the controller could receive other inputs (such as motion detection, time of day, etc.) and use these inputs to alter the resistance of photo-resistor 802. Those skilled in the art will recognize that the microprocessor could utilize external A/D and/or D/A circuits. Similarly, those skilled in the art will readily recognize that the digital microcontroller 816 can be replaced with analog circuitry to control the brightness of LED 804.

The purpose of daylight harvesting is to save energy when ambient natural light conditions allow reduction of artificial light. The present dimmer effectively accomplishes this when operated with a light source using the ballast described in U.S. patent application Ser. No. 12/277,014, filed on Nov. 24, 2008. The use of such a ballast with the dimmer described herein allows a generally commensurate reduction in energy consumption when dimming. Thus, the combination realizes the benefits of daylight harvesting while maintaining a high efficiency and high power factor, without any flickering of light, even when dimmed to a very low level. Thus, this allows artificial lights to be dimmed when there is sufficient ambient light and increased gradually as ambient light increases. This combination allows energy savings to be realized.

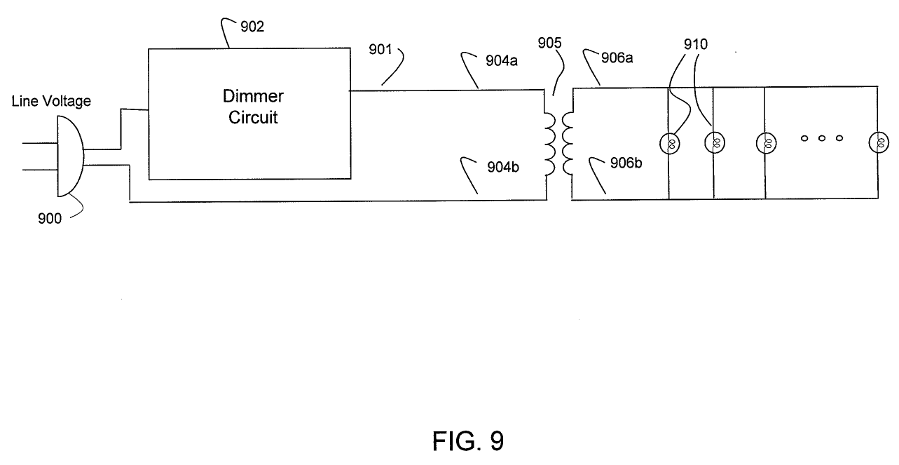

FIG. 9 illustrates another embodiment of the present invention wherein the dimmer is used for dimming low voltage lighting, such as landscaping (outdoor) lighting or ornamental lighting (e.g., signage or holiday lights). In FIG. 9, a dimmer circuit 902, which may be any of the previously identified embodiment of the dimmer circuits, is used to connect to line voltage via a plug 900. The output 901 of the dimmer circuit 902 is connected a transformer 905 by connecting to the input terminal 904a on the primary winding. The transformer typically is a step-down transformer, and converts the input voltage, which can be as high as the line voltage (when not dimmed) to a lower voltage, such as 12 volts. A series of light sources 910 (such as LEDs or other types) are connected to the secondary winding of the transformer. Such applications may be used for low-voltage lighting applications. When the dimmer circuit 902 is activated, the voltage output to the transformer 905 will have less energy delivered relative to the line voltage into the dimmer circuit, and the light output of the light sources 910 will be dimmed. The dimmer circuit can also be combined with the ambient light detection circuit of FIG. 8 to automatically dim the lights, or with other circuitry for accomplishing the same function. Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

1. A method of modifying a line voltage at a line frequency for dimming a light source, comprising the steps of:
storing energy in a capacitor having a first terminal and a second terminal from a power source, wherein said first terminal of said capacitor is coupled to a first node and the second terminal of the capacitor is coupled to a first terminal of a primary winding of a transformer, wherein a second terminal of said primary winding is coupled to a second node;
providing a time varying voltage at a third node, wherein an adjustable resistor has a first terminal coupled to said first node and a second terminal coupled to said third node;
activating a diac having a first terminal and a second terminal, wherein said first terminal is coupled to said third node, wherein said diac is activated when said time variable voltage at the third node reaches a threshold voltage;
activating a solid state switch having a first terminal, a second terminal, and a gate terminal, wherein said first terminal is coupled to said first node, said second terminal is coupled to said second node, and said gate terminal is coupled to said second terminal of said diac, said solid state switch activated as a result of said diac being activated, thereby connecting said first node to said second node;
discharging energy stored in said capacitor as a result of activating said solid state switch, said discharged energy provided to said primary winding of the transformer thereby activating a transistor, said transistor having a first terminal coupled to said first node and a second terminal coupled to said gate of said solid state switch whereby said transistor causes said solid state switch to remain activated for a first time period; and
deactivating said solid state switch after a second time period, wherein said second time period is longer than said first time period and less than a duration of a half cycle of the line frequency.

2. The method as defined in claim 1, wherein the transistor has a third terminal coupled to a secondary winding of the transformer.

3. The method as defined in claim 1, wherein the capacitor receives energy from a full wave bridge rectifier.

4. The method as defined in claim 2, wherein the step of:
discharging energy stored in said capacitor as a result of activating said solid state switch, said discharged energy provided to said primary winding of said transformer thereby activating a transistor,
comprises:
discharging energy stored in said capacitor as a result of activating said solid state switch, said discharged energy provided to said primary winding of said transformer thereby activating said transistor, wherein said transistor comprises either a first transistor or a second transistor based on whether a voltage at said capacitor is either negative or positive with respect to said first node.

5. The method of claim 1 wherein said transistor when activated is configured to provide a current to the gate of the solid state switch, thereby maintaining the solid state switch in an activated condition.

6. A dimmer circuit for controlling the light intensity emitted from a light, comprising:
a transformer having a primary winding with a first terminal and a second terminal, said first terminal of the primary winding coupled to an output of a full wave bridge rectifier, said second terminal of the primary winding coupled to a first node, said transformer having a secondary winding with a first terminal and a second terminal, said second terminal of said secondary winding coupled to a second node;
an adjustable resistor having a first terminal coupled to said first node and a second terminal coupled to a third node;
a first capacitor having a first terminal coupled to said third node and a second terminal coupled to said second node, whereby a time varying voltage is present at said third node;
a diac having a first terminal coupled to said third node, wherein said diac is configured to be activated when said time varying voltage at said third node reaches a threshold voltage, said diac having a second terminal;
a solid state switch comprising a silicon controlled rectifier (“SCR”) having a first terminal coupled to said first node and a second terminal coupled to said second node, said solid state switch having a gate terminal coupled to said second terminal of said diac, said solid state switch configured to be activated as a result of said diac being activated; and
a transistor having said first terminal coupled to said first node and a second terminal coupled to said gate terminal of said solid state switch, said transistor configured to be activated by energy provided from a second capacitor having a first terminal and a second terminal wherein the first terminal of said second capacitor is coupled to said first terminal of said secondary winding and said second terminal of said second capacitor is coupled to said second node, wherein said transistor maintains activation of said solid state switch for a first time period.

7. The method of claim 6 wherein the second capacitor receives a charge on said first terminal provided by a current provided from the secondary winding of the transformer via a diode and resistor connected in series.

8. A dimmer circuit comprising:
a solid state switch configured to selectively couple a first node to a second node, wherein the first node receives a line voltage at a line frequency;
a biasing circuit configured to actuate the solid state switch after a delay after the beginning of a half-cycle of the line frequency, the delay based on a resistance setting of a variable resistor; and
a charge circuit coupled to said first node, said second node, and to a gate of the solid state switch, said charge circuit configured to maintain activation of the solid state switch for a period of time beginning with said actuating of the solid state switch and ending prior to ending of the half-cycle.

9. The dimmer circuit of claim 8 wherein the solid state switch comprises a silicon controlled rectifier (SCR).

10. The dimmer circuit as defined in claim 9, wherein the charge circuit comprises a transformer having a primary winding and a secondary winding operable to produce a generated voltage in response to actuating the solid state switch wherein said primary winding has a first terminal coupled to said first node via a first capacitor, said primary winding having a second terminal coupled to said second node, said secondary winding having a first terminal coupled to said second node and a second terminal coupled to said second node via a second capacitor, said second terminal of the secondary winding coupled to a transistor coupled to said gate of said solid state switch, said transistor configured to be activated for less than 2 milliseconds so as to maintain activation of said solid state switch.

11. A dimmer circuit as defined in claim 9, wherein the transistor is configured to provide a biasing current to the gate of the solid state switch for said period of time.

12. A dimmer circuit as defined in claim 8, wherein the solid state switch comprises an SCR and as a result of a current flowing through the SCR during the half-cycle of the line current, the SCR remains activated for said period of time.

13. A dimmer circuit as defined in claim 12, wherein the SCR is deactivated at the end of the half-cycle of the line current.

14. A dimmer circuit as defined in claim 9 wherein said biasing circuit further comprises:
a variable resistor having a first terminal coupled to said first node and a second terminal coupled to a third node;
a capacitor having a first terminal coupled to said third node and a second terminal coupled to said second node; and
a diac having a first terminal coupled to said third node and a second terminal coupled to a gate terminal of said solid state switch, wherein the diac is configured to provide an output current to actuate the solid state switch when a voltage at the third node exceeds a predetermined threshold based on a value of the variable resistor.

15. A dimmer circuit for controlling the light intensity emitted from a light, comprising:
a silicon controlled rectifier (SCR) having a first terminal, a second terminal and a gate terminal, said first terminal coupled to a first node and said second terminal coupled to a second node;
an adjustable resistor having a first terminal coupled to the first node and a second terminal coupled to a third node;
a diac having a first terminal coupled to the third node and a second terminal coupled to the gate terminal of the SCR;
a first capacitor having a first terminal coupled to the third node and a second terminal coupled to the second node;
a transistor having a first terminal coupled to the first node, a second terminal coupled to the gate terminal of the SCR, said transistor having a third terminal coupled to a fourth node via a first resistor;
a zener diode having a cathode coupled to said fourth node and an anode coupled to the second node;
a second resistor having a first terminal coupled to said fourth node and a second terminal coupled to said second node; and
a second capacitor having a first terminal coupled to said fourth node and a second terminal coupled to said second node.

16. The dimmer circuit of claim 15 further comprising a transformer having a primary winding and a secondary winding, wherein a terminal of said secondary winding is coupled to said fourth node via a diode.

17. A dimmer circuit for controlling the light intensity emitted from a light, comprising:
a triac having a first terminal coupled to a first node and a second terminal coupled to a second node;
an adjustable resistor having a first terminal coupled to the first node and a second node coupled to a third node;
a diac having a first terminal coupled to the third node and a second terminal coupled to a gate of the triac;
a first capacitor having a first terminal coupled to the third node and a second terminal coupled to the second node;
a primary winding having a first terminal and a second terminal wherein the first terminal is coupled to the second node;
a second capacitor having a first terminal coupled to the second terminal of the primary winding and a second terminal coupled to the first node;
a secondary winding having a first terminal and a second terminal wherein the first terminal is coupled to the second node;
a first diode having an anode coupled to the second terminal of the secondary winding and a cathode coupled to a fourth node;
a third capacitor having a first terminal coupled to the fourth node and a second terminal coupled to the second node;
a first zener diode having a cathode coupled to the fourth node and an anode coupled to the second node;
a first transistor having a first terminal coupled to the fourth node via a second resistor, said first transistor having a second terminal coupled to the first node via a cathode of a second diode, and said first transistor having a third terminal coupled to the gate of the triac;
a third diode having a cathode coupled to the second terminal of the secondary winding and an anode coupled to a fifth node;
a fourth capacitor having a first terminal coupled to the fifth node and a second terminal coupled to the second node;
a second zener diode having an anode coupled to the fifth node and a cathode coupled to the second node; and
a second transistor having a first terminal coupled to the fifth node via a third resistor, said second transistor having a second terminal coupled to the first node via a cathode of a fourth diode, and said second transistor having a third terminal coupled to the gate of the triac.

18. The system of 17 wherein the second node is configured to receive power from a power source and the first node is configured to be coupled to a ballast.

19. The dimmer circuit of claim 17 further comprising:
a fourth resistor having a first terminal and a second terminal wherein the first terminal is coupled to the fourth node and the second terminal is coupled to the second node; and
a fifth resistor having a first terminal and a second terminal, wherein the first terminal is coupled to the second node and the second terminal is coupled to the fifth node.

20. The dimmer circuit of claim 17 wherein the value of the first capacitor and the value of the adjustable resistor are configured to cause the voltage of the third node to trigger the diac no more than 1/120^{th} of a second after a non-zero input voltage is present at the first node.

21. A dimmer circuit comprising:
a first node configured to be coupled to a light source;
a second node configured to be coupled to household power;
a first capacitor having a first terminal coupled to the first node;
a transformer having a first terminal of a primary winding and a second terminal of the primary winding, wherein said first terminal of said transformer is coupled to said second terminal of said first capacitor, wherein said second terminal of the primary winding is coupled to the second node;
a solid state switch having a first terminal, a second terminal, and a gate terminal, wherein said first terminal is coupled to said first node and said second terminal is coupled to said second node;
an adjustable resistor having a first terminal and a second terminal, wherein said first terminal is coupled to said first node and said second terminal is coupled to a third node;
a diac having a first terminal and a second terminal, wherein said first terminal is coupled to said third node, wherein said second terminal of said diac is coupled to said gate terminal of said solid state switch;
a second capacitor having a first terminal and a second terminal, wherein said first terminal is coupled to said third node and said second terminal is coupled to said second node;
a first full wave bridge rectifier having a first and second terminal coupled to a first terminal and a second terminal of a secondary winding of said transformer, said full wave bridge rectifier having a first output terminal coupled to a fourth node via a diode and a second output terminal coupled to a fifth node;
a first resistor having a first terminal coupled to the fourth node and a second terminal coupled to the fifth node;
a zener diode having an anode and cathode wherein said cathode is coupled to said fourth node and said anode is coupled to said fifth node;
a third capacitor having a first terminal and a second terminal wherein said first terminal is coupled to said fourth node and said second terminal is coupled to said fifth node;
a second resistor having a first terminal and a second terminal, said first terminal coupled to a gate terminal of a transistor and said second terminal coupled to said fourth node;
a transistor having a first terminal and a second terminal, wherein said second terminal is coupled to said fifth node; and
a second full wave bridge rectifier having a first input terminal coupled to said first node and having a second input terminal coupled to said gate terminal of said solid state switch, said second full wave bridge rectifier having a first output terminal coupled to said first terminal of said transistor, said second full wave bridge rectifier having a second output terminal coupled to said second terminal of said transistor.

22. The system of claim 21 wherein the household power comprises a voltage greater than 200 volts AC.

23. A dimmer circuit comprising:
a full wave bridge rectifier have a first input coupled to a line voltage and a second input coupled to a light source, said full wave bridge having a first output terminal and a second output terminal, wherein said second output terminal is coupled to a first node;
an inductor having an inductance less than 400 micro Henries, said inductor having a first terminal coupled to the first output terminal of the full wave bridge rectifier, said inductor having a second terminal coupled to a second node;
a silicon control rectifier (SCR) having a first terminal coupled to the first node, a second terminal coupled to the second node, and a gate terminal coupled to a third node;
an adjustable resistor having a first terminal coupled to the second node and a second terminal coupled to a third node;
a diac having first terminal coupled to the third node and a second terminal coupled to the gate terminal of the SCR; and
a capacitor coupled having a first terminal coupled to the third node and a second terminal coupled to the first node.

24. A dimmer circuit for controlling the light intensity emitted from a light, comprising:
a transformer having a primary winding with a first terminal and a second terminal, said first terminal of the primary winding coupled to an output of a full wave bridge rectifier, said second terminal of the primary winding coupled to a first node, said transformer having a secondary winding with a first terminal and a second terminal, said second terminal of said secondary winding coupled to a second node;
an adjustable resistor having a first terminal coupled to said first node and a second terminal coupled to a third node;
a first capacitor having a first terminal coupled to said first node and a second terminal coupled to said third node, whereby a time varying voltage is present at said third node;
a diac having a first terminal coupled to said third node, said diac configured to be activated when said time varying voltage at said third node reaches a threshold voltage, said diac having a second terminal;
a solid state switch comprising a silicon controlled rectifier (“SCR”) having a first terminal coupled to said first node and a second terminal coupled to said second node, said solid state switch having a gate terminal coupled to said second terminal of said diac, said solid state switch configured to be activated as a result of said diac being activated;
a transistor having a first terminal, a second terminal and a third terminal, said first terminal coupled to said first node, said second terminal coupled to said gate terminal of said solid state switch;
a first resistor having a first terminal coupled to the gate terminal of the transistor, and a second terminal coupled to a fourth node;
a second capacitor having first terminal coupled to the fourth node and a second terminal coupled to the second node;
a zener diode having a cathode coupled to the fourth node and an anode coupled to the second node;
a second resistor having a first terminal coupled to the fourth node and a second terminal coupled to the second node;
a third resistor having a first terminal coupled to the fourth node and a second terminal; and
a diode having a cathode coupled to the second terminal of the third resistor and an anode connected to said first terminal of said secondary winding of the transformer.
